(19) United States
(12) Patent Application Publication
(10) Pub. No.: US 2025/0103056 A1
(43) Pub. Date: Mar. 27, 2025

(54) TRIPLE INTEGRATED CAMERA SYSTEM FOR THE DEVELOPMENT OF AUTONOMOUS VEHICLE THAT CAN ESCAPE OBSTACLES

(71) Applicants: BANDIRMA ONYEDI EYLUL UNIVERSITESI, Balikesir (TR); TARSENS ARASTIRMA VE GELISTIRME SANAYI VE TICARET LIMITED SIRKETI, Balikesir (TR)

(72) Inventors: Mustafa Cem ALDAG, Balikesir (TR); Celil Serhan TEZCAN, Balikesir (TR)

(73) Assignees: BANDIRMA ONYEDI EYLUL UNIVERSITESI, Balikesir (TR); TARSENS ARASTIRMA VE GELISTIRME SANAYI VE TICARET LIMITED SIRKETI, Balikesir (TR)

(21) Appl. No.: 18/574,053

(22) PCT Filed: Mar. 15, 2023
(86) PCT No.: PCT/TR2023/050255

§ 371 Date: Dec. 25, 2023

(30) Foreign Application Priority Data
Sep. 22, 2022 (TR) 2022/014624

(51) Int. Cl. G05D 1/622; B64U 20/87; G05D 109/20; G05D 111/10; G06V 20/58

(52) U.S. Cl. CPC G05D 1/622; B64U 20/87; G06V 20/58; B64U 2201/10; G05D 2109/20; G05D 2111/10

(57) ABSTRACT

A triple integrated camera system for the development of an autonomous vehicle that can avoid obstacles that allows successful autonomous flight by detecting both the width and height of the surrounding objects through triple integrated camera systems and its feature is; at least three cameras that enable image data to be obtained from surrounding objects, a sensor unit, which enables the acquisition of width and/or height data as a result of working in coordination with the camera, a processor, which enables the calculation of both the widths and heights of the surrounding objects by processing the sensor data coming from the sensor unit working in cooperation with the camera through algorithm, a protective outer layer that protects the system against external factors.

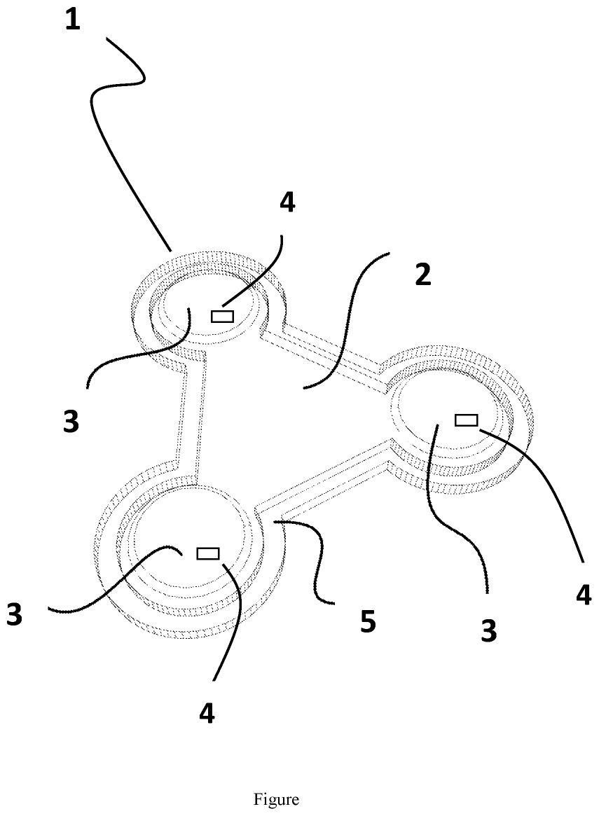

### CROSS REFERENCE TO RELATED APPLICATIONS

This application is a national stage entry of International Application No. PCT/TR2023/050255, filed on Mar. 15, 2023, which is based upon and claims foreign priority to Turkey Patent Application No. 2022/014624, filed on Sep. 22, 2022, the entire contents of which are incorporated herein by reference.

### TECHNICAL FIELD

This invention relates to a triple integrated camera system for the development of an autonomous vehicle that can avoid obstacles that allows successful autonomous flight by detecting both the width and height of the surrounding objects through triple integrated camera systems.

### BACKGROUND

Nowadays, the vehicles that have vertical take-off and landing systems can make landings and exits without the need for runway; among the advantages of the system are features such as hovering, fast positioning and flexible maneuvering capabilities. However, although vertical take-off and landing systems have various advantages, they are disadvantageous because they increase the cost due to both fuel and maintenance costs, limit the system in terms of features such as maximum cruising speed, efficiency and durability, and create a complex system.

In order to minimize these disadvantageous features of vertical take-off and landing systems, various solutions have been developed by combining them with vertical take-off and fixed-wing systems. However, the majority of these systems are pilot controlled and stereo cameras are used to avoid obstacles.

In existing systems, stereo imaging, which makes distance calculation possible by combining images obtained from different points with two cameras, is widely used. However, in these systems, in case any of the cameras become dirty or malfunction, this distance calculation cannot be made. At the same time, since only the width of the objects can be detected in the systems using stereo cameras, the inability to detect the height creates a disadvantageous situation. Because it is not sufficient to detect only the width of the objects in order for the vehicles using these systems to automatically avoid obstacles.

“Visual Observer for Unmanned Aerial Vehicles” is described in application numbered US2021350162. In some examples, a device may receive, from a first camera, a plurality of images of an airspace corresponding to an area of operation of an unmanned aerial vehicle (UAV). The device may detect, based on the plurality of images from the first camera, a candidate object approaching or within the airspace. Based on detecting the candidate object, the device may control a second camera to direct a field of view of the second camera toward the candidate object. Further, based on images from the second camera captured at a first location and images from at least one other camera captured at a second location, the candidate object may be determined to be an object of interest. In addition, at least one action may be taken based on determining that the candidate object is the object of interest.

In the current system discussed above, since a system using stereo (dual) cameras is considered, in case of any problem observed in the cameras, the vehicle in which the system is used cannot detect the distance successfully and the operation has to stop. At the same time, in systems using stereo cameras, only the width calculation of the surrounding objects is not sufficient for vehicles to avoid obstacles.

As a result, a new technology is needed that can overcome the above-mentioned disadvantages and measures the surrounding objects by detecting both width and height through triple camera systems integrated into vehicles, supports autonomous flight without pilot control, has a high ability to automatically avoid obstacles, minimizes accidents, has a low margin for error and cost, is practical, does not limit the system, and has high system success.

### SUMMARY

This invention is a triple integrated camera system for developing an autonomous vehicle that can escape obstacles, and its feature is; that it is a new technology that allows autonomous flight to be successfully performed by detecting both the width and height of surrounding objects through triple integrated camera systems, minimizes accidents, has a high ability to automatically escape obstacles, has a low margin for error and cost, is practical, does not limit the system, and has high system success.

Thanks to the triple integrated camera system, which is the subject of the invention, it is aimed to develop an autonomous vehicle that can automatically escape from obstacles without pilot control in order for vehicles to perform live transport/live rescue activities in cases of natural disasters, emergencies, etc.

The system that is the subject of the invention; Miniature unmanned aerial vehicles, miniature unmanned cargo vehicles, manned/unmanned aerial vehicles, armed/unarmed aerial vehicles, etc. it uses image detection and image processing area, as well as artificial intelligence and pattern identification technologies to enable vehicles to move autonomously.

The usage area of the inventive system covers a wide range including the toy industry, unmanned aerial vehicles, defense industry, etc.

As a result of attaching the triple camera system of the invention to the front and/or rear and/or any surface of the vehicles, the images coming from the three cameras are processed.

Since the vehicle size is defined in the system in the vehicles in which the inventive system is used, it is directly determined whether the obstacles, whose width and height are determined, can be passed, or if the obstacles can be passed, in which direction and how much maneuver should be made.

According to the size of the vehicle in which the system of the invention is mounted, how many obstacles are commanded and/or direct information is given about the distance of the obstacles and/or the size of the obstacles.

By using the triple integrated camera system, which is the subject of the invention, any negative situation such as sensor failure or camera contamination is prevented from preventing the success of autonomous flight.

Thanks to the triple integrated camera system, which is the subject of the invention, both the width and height of the objects are determined so that the vehicles in which the inventive systems are used can operate autonomously and automatically avoid obstacles in order to realize all the objectives mentioned above and which will emerge from the detailed description below.

The structural and characteristic features and all advantages of the product subject to the invention will be understood more clearly thanks to the figures given below and the detailed explanation written by making reference to these figures, and therefore the evaluation should be made by taking these figures and detailed explanation into consideration.

### BRIEF DESCRIPTION OF THE DRAWINGS

The invention will be described with reference to the accompanying figures, so that the features of the invention will be more clearly understood and appreciated, but the purpose of this is not to limit the invention to these certain regulations. On the contrary, it is intended to cover all alternatives, changes and equivalences that can be included in the area of the invention defined by the accompanying claims. The details shown should be understood that they are shown only for the purpose of describing the preferred embodiments of the present invention and are presented in order to provide the most convenient and easily understandable description of both the shaping of methods and the rules and conceptual features of the invention. In these drawings.

FIGURE is a view of the triple camera system.

The figures to help understand the present invention are numbered as indicated in the attached image and are given below along with their names.

### DESCRIPTION OF REFERENCES

1. Triple Camera System
2. Processor
3. Camera
4. Sensor Unit
5. Protective Outer Layer

### DETAILED DESCRIPTION OF THE EMBODIMENTS

The invention includes three cameras (3) that provide image data from surrounding objects, a sensor unit (4) that provides sensor data as a result of coordinated work with the camera (3), a processor (2) that allows calculating both the width and height of surrounding objects by processing sensor data from the sensor unit (4) working in cooperation with the camera (3) through an algorithm, a protective outer layer (5) to provide protection against external factors.

The invention includes three cameras (3) positioned in the corners and a sensor unit (4) that works simultaneously with the cameras (3).

The invention includes three cameras (3) that allow image data to be obtained from surrounding objects.

The invention includes a sensor unit (4) that allows sensor data to be obtained as a result of working in a coordinated manner with the camera (3) using image data obtained from the camera (3).

The invention includes a processor (2) that allows both the widths and heights of surrounding objects to be calculated by processing image data from the camera (3) and sensor data from the sensor unit (4) working in cooperation with the camera (3) by means of an algorithm.

The invention includes a processor (2) that calculates whether the size of the vehicle on which the triple camera system (1) is mounted, and the width and height of the obstacles can be passed, or if the obstacles can be passed, in which direction and how much maneuver should be performed.

The invention includes a processor (2) that gives how many commands from the surrounding obstacles and/or gives information about the distance and/or the size of the obstacles, according to the size of the vehicle in which the triple camera system (1) is mounted.

The basic elements constituting the triple camera system (1), which is the subject of the invention; the processor (2), the camera (3), the sensor unit (4) and the protective outer layer (5).

The invention includes three cameras (3) positioned at the corners and the sensor unit (4) working simultaneously with the cameras (3).

The invention includes a processor (2) that processes the image data coming from the camera (3) and the sensor data coming from the sensor unit (4).

The invention provides the acquisition of image data from the surrounding objects by means of three cameras (3) positioned at the corners.

The invention provides the acquisition of sensor data as a result of the sensor unit (4) working in coordination with the camera (3) by using the image data obtained from the camera (3).

The triple camera system (1), which is the subject of the invention, contains a protective outer layer (5) in order to provide protection against external factors.

The invention provides the calculation of both the widths and heights of the surrounding objects by processing the image data of the surrounding objects from the camera (3) and the sensor data coming from the sensor unit (4) working in cooperation with the camera (3) through the algorithm run on the processor (2).

If the size of the vehicle in which the triple camera system (1) is installed is defined to the processor (2), it is calculated whether the obstacles whose widths and heights are determined by the processor (2) can be passed, or if they are to be passed, in which direction, how long a maneuver should be performed.

According to the size of the vehicle in which the triple camera system (1) is installed, the processor (2) can give how many commands from the surrounding obstacles and/or provide information about the distance and/or the size of the obstacles.

What is claimed is:

1. A triple integrated camera system for a development of an autonomous vehicle that can escape obstacles comprising;
at least three cameras that enable image data to be obtained from surrounding objects,
a sensor unit, which enables an acquisition of width and/or height data as a result of working in coordination with the at least three cameras,
a processor, which enables a calculation of both the widths and heights of the surrounding objects by processing sensor data coming from the sensor unit working in cooperation with the at least three cameras through an algorithm, and
a protective outer layer that protects the triple integrated camera_system against external factors.

2. The triple integrated camera system according to claim 1, further comprising three cameras positioned at corners and a sensor unit working simultaneously with the three cameras.

3. The triple integrated camera system according to claim 1, further comprising at least three cameras that enable image data to be obtained from the surrounding objects.

4. The triple integrated camera system according to claim 1, wherein the sensor unit enables the acquisition of sensor data as a result of working in coordination with the camera by using the image data obtained from the camera.

5. The triple integrated camera system according to claim 1, wherein the processor provides a calculation of both the widths and heights of the surrounding objects by processing the image data coming from the camera and the sensor data coming from the sensor unit working in cooperation with the camera through an algorithm.

6. The triple integrated camera system according to claim 1, further comprising a processor that calculates a size of the vehicle on which the triple camera system is mounted, and calculates whether the obstacles whose widths and heights are determined can be passed, or in which direction and how much maneuver should be done if the obstacles can be passed.

7. The triple integrated camera system according to claim 1, wherein the triple camera system comprises a processor that gives information about a distance from the obstacles and/or a size of the obstacles and/or the distance of the obstacles according to a size of the relevant vehicle on which it is mounted.
